(19) United States
(12) Patent Application Publication
(10) Pub. No.: US 2003/0199243 A1
(43) Pub. Date: Oct. 23, 2003

(54) Motor vehicle with means for changing the air inside the cabin

(76) Inventor: Giuseppe Castiglione, Nave (IT)

Correspondence Address: MODIANO & ASSOCIATI, Via Meravigli, 16, MILANO, 20123, IT

(21) Appl. No.: 10/397,305

(22) Filed: Mar. 27, 2003

(30) Foreign Application Priority Data
Apr. 19, 2002 (IT) MI2002A000842

(51) Int. Cl. B60H 1/00; B60H 1/26

(52) U.S. Cl. 454/137

(57) ABSTRACT

A motor vehicle with elements for changing the air inside the cabin, comprising, at the roof of the cabin, a box-like body that affects most of the roof and has, on a face directed toward the cabin, a grilled portion that forms a chamber inside the box-like body, the chamber being connected to suction ducts that lead outside the vehicle.

### BACKGROUND OF THE INVENTION

The present invention relates to a motor vehicle with means for changing the air inside the cabin.

As is known, there is a current trend to considerably use motor vehicles, and therefore it is increasingly necessary to make the motor vehicle comfortable in view of the fact that the time spent in it by the user is considerable.

Currently, very limited changes of air are generally performed in the cabins of motor vehicles, because both climate control systems and ordinary ventilation systems have small air outlets and do not actually aspirate the air from the inside the vehicle to expel it outside.

Accordingly, the air inside the cabin can be stale in some cases, and this aspect is felt even more strongly in the presence of smokers.

Another problem arises from the fact that stubs of cigarettes and the like remain in the cabin for a relatively long time and accordingly the upholstery of the cabin is impregnated with a bad odor that is particularly persistent.

### SUMMARY OF THE INVENTION

The aim of the invention is to solve the problem noted above, by providing a motor vehicle with means for changing the air inside the cabin that allows to have a continuous and forced air change, thus making the travelers' stay on board much more pleasant.

Within this aim, an object of the invention is to provide a motor vehicle in which the driver can be spared from being distracted from driving in order to correctly extinguish a cigarette in the ashtray.

Another object of the present invention is to provide a motor vehicle in which the risk arising from stubs thrown out from the windows of the cabin while traveling is avoided radically, accordingly eliminating the risks of setting fires linked to this bad habit.

Another object of the present invention is to provide a motor vehicle that thanks to its particular constructive characteristics is capable of giving the greatest assurances of reliability and safety in use.

This aim and these and other objects that will become better apparent hereinafter are achieved by a motor vehicle with means for changing air inside the cabin, characterized in that it comprises, at a roof of the cabin, a box-like body that affects most of said roof and has, on a face directed toward the cabin, a grilled portion in order to form a chamber inside said box-like body, said chamber being connected to at least one suction duct that leads outside the vehicle.

### BRIEF DESCRIPTION OF THE DRAWINGS

Further characteristics and advantages of the invention will become better apparent from the description of a preferred but not exclusive embodiment of a motor vehicle in general with means for changing the air in the cabin, illustrated only by way of non-limitative example in the accompanying drawings, wherein:

FIG. 1 is a schematic perspective view of the air suction means;

FIG. 2 is a perspective schematic view of an ashtray applied to the motor vehicle;

FIG. 3 is a perspective view of a motor vehicle with the air suction means and with the ashtray.

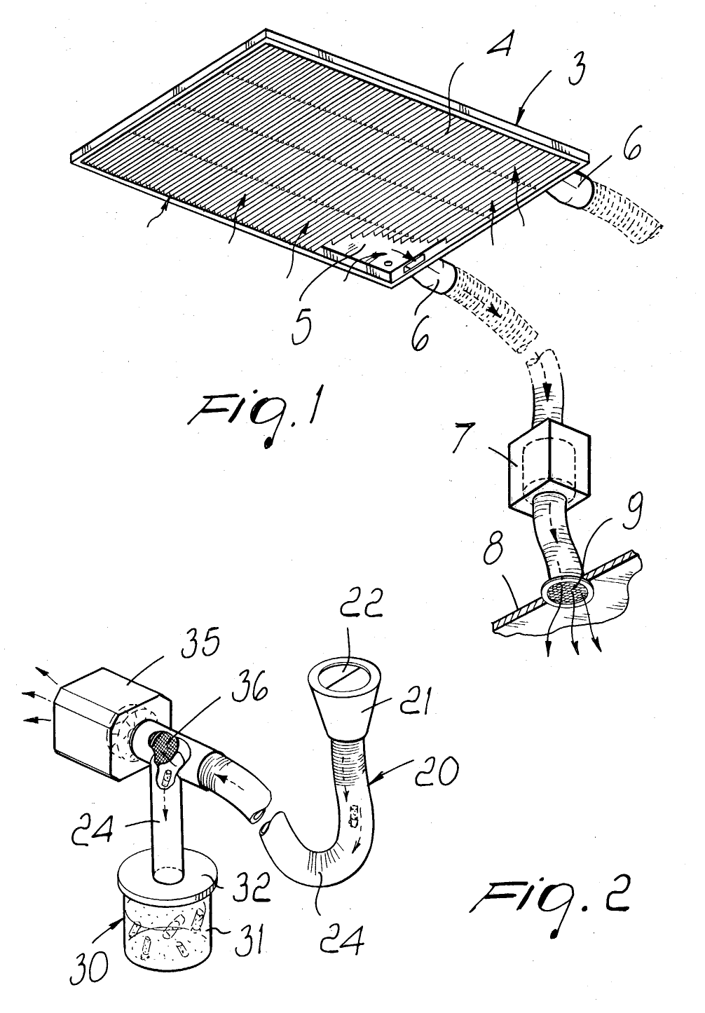

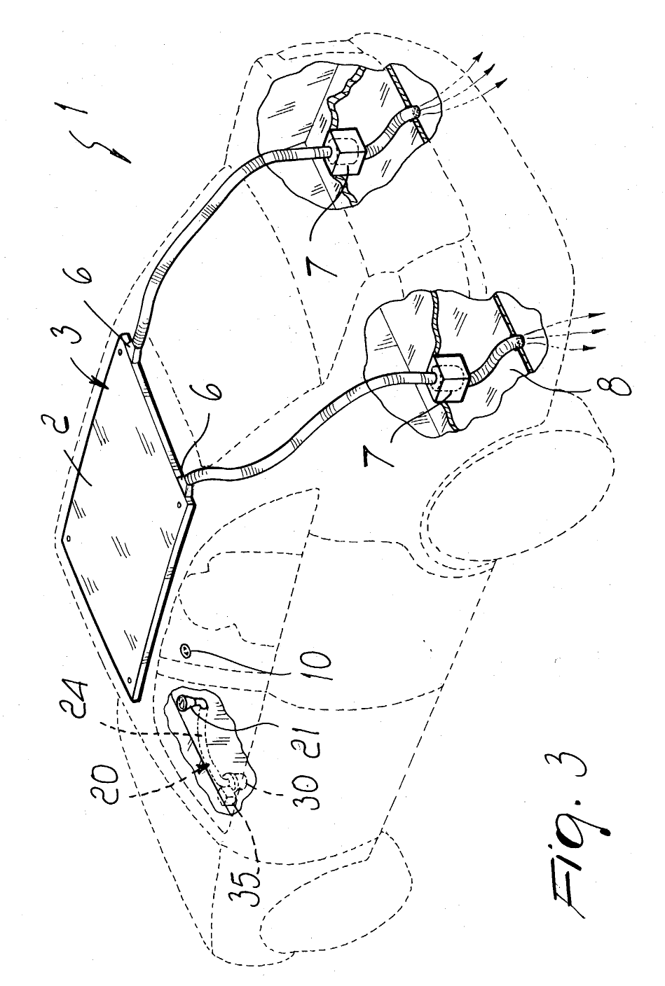

### DESCRIPTION OF THE PREFERRED EMBODIMENTS

With reference to the figures, the motor vehicle in general with means for changing the air inside the cabin, according to the invention, generally designated by the reference numeral 1, comprises at the roof of the cabin, designated by the reference numeral 2, air suction means, which have a box-like body 3 that is structured so as to affect most of the roof of the cabin, possibly leaving free a small central portion in the front part due to the presence of any further accessories of the motor vehicle.

The box-like body 3 has, on its face that is directed toward the cabin, a grilled portion 4 which is preferably provided with a plurality of laminas that lie transversely and are arranged side by side.

The grilled portion 4 forms a chamber 5 at which suction ducts 6 end; such ducts are advantageously spaced and located at the rear lateral regions of the chamber, so as to achieve very uniform suction.

The grilled portion 4 is advantageously of the removable type, so as to allow easy cleaning.

Aspirators 7 are provided on the suction ducts 6, which advantageously extend toward the rear part of the motor vehicle, and are preferably arranged at the free space formed in the region of the trunk of the vehicle.

The ducts 6 lead outside, preferably at the floor pan 8 or optionally in the bumper, and are closed by an outlet grille 9 that prevents the accidental entry of insects, soil and so forth.

The aspirators 7 preferably have two speeds and can be arranged in small compartments provided under the floor pan 8 of the trunk or in any other free space.

There is also an actuation switch 10, which is advantageously located on the dashboard.

In order to make the vehicle particularly comfortable, there is also an ashtray, generally designated by the reference numeral 20, which is designed to extinguish the stubs.

The ashtray 20 has an intake 21, which is preferably located in the central part of the dashboard and is provided with closure shutters 22 that close automatically or manually and are provided for example by means of retractable hemispheres.

A conveyance tube 24, made of fireproof material, is connected to the intake 21 and reaches a stub extinguishing container 30, which has a container body 31 provided with a lid 32 onto which the end portion of the conveyor 24 engages.

Water to extinguish the stubs immediately can be introduced in the container body 31.

In a central portion of the conveyance tube 24 there is a stub aspirator 35, provided with a suction grille 36, which is arranged at the upper end of the end portion of the conveyance tube 24 above the container body 31, so that the stubs entrained by the generated air flow strike the grille, which can be provided by means of a filter 36 that can be removed to clean it and/or replace it, fall into the container 31, where they are extinguished automatically.

The aspirator 35 can be activated directly by the closure shutters 22, which accordingly also act as a switch for activating the ashtray.

The container body 31 is advantageously provided in an easily accessible region, so that it can be removed easily to dispose of its contents and to refill it with a dose of water that extinguishes the stubs immediately.

From the above description it is therefore evident that the invention achieves the proposed aim and objects, and in particular the fact is stressed that a motor vehicle is provided in which there are two extremely important elements that can be optionally used independently of each other.

In practice, it is possible to provide a suction device that produces a forced air changing inside the motor vehicle and which by extending along substantially the entire surface of the roof of the cabin allows to provide optimum air aspiration.

Moreover, it is possible to provide an ashtray of a new type, which allows to remove the stubs automatically from the interior of the vehicle, extinguishing them immediately and preventing bad odors from returning toward the vehicle cabin.

The invention thus conceived is susceptible of numerous modifications and variations, all of which are within the scope of the appended claims.

All the details may further be replaced with other technically equivalent elements.

In practice, the materials used, as well as the dimensions and the contingent shapes, may be any according to requirements.

The disclosures in Italian Patent Application No. MI2002A000842 from which this application claims priority are incorporated herein by reference.

What is claimed is:

1. A motor vehicle with means for changing the air inside the cabin, comprising, at a roof of the cabin, a box-like body that affects most of said roof and has, on a face directed toward the cabin, a grilled portion in order to form a chamber inside said box-like body, said chamber being connected to at least one suction duct that leads outside said vehicle.

2. The motor vehicle according to claim 1, wherein said grilled portion is detachable.

3. The motor vehicle according to claim 1, wherein said grilled portion has laminas that are arranged transversely and side by side.

4. The motor vehicle according to claim 1, comprising two suction ducts, which are connected to said chamber and end externally at a floor pan of the vehicle.

5. The motor vehicle according to claim 1, comprising two suction ducts that lead into the bumper.

6. The motor vehicle according to claim 5, comprising an exit grille located at an end of said suction ducts.

7. The motor vehicle according to claim 1, comprising aspirators that are interposed on said at least one suction duct.

8. The motor vehicle according to claim 7, wherein said aspirators have two speeds.

9. The motor vehicle according to claim 7, wherein said aspirators are located under the floor pan of the trunk of the vehicle.

10. The motor vehicle according to claim 7, comprising a switch for operating said aspirators, which is located on the dashboard of the motor vehicle.

11. A motor vehicle, comprising, inside the cabin, an ashtray that has an intake with closure elements that is connected to an end of a conveyance tube that leads, at another end thereof, into a stub extinguishing container in which water can be introduced, a stub aspirator being provided on said conveyance tube.

12. The motor vehicle according to claim 11, wherein said closure elements are opened manually.

13. The motor vehicle according to claim 11, wherein said closure elements are opened and closed automatically.

14. The motor vehicle according to claim 11, wherein said closure elements of the ashtray are constituted by shutters.

15. The motor vehicle according to claim 11, wherein said conveyance tube is made of fireproof material.

16. The motor vehicle according to claim 11, wherein said stub aspirator is provided with a suction grille located at an upper end of an end portion of said conveyance tube above said stub extinguishing container.

17. The motor vehicle according to claim 16, wherein said suction grille is removable to clean it and/or replace it.

18. The motor vehicle according to claim 11, wherein said stub aspirator is activated by said closure elements of the ashtray.

19. The motor vehicle according to claim 11, wherein said stub extinguishing container is arranged in a region of the motor vehicle that can be accessed for maintenance.
